(19) United States
(12) Patent Application Publication
(10) Pub. No.: US 2026/0316804 A1
(43) Pub. Date: Oct. 15, 2026

(54) TRAIN WHEEL BEARING FAILURE MONITORING SYSTEM

(71) Applicant: David E. Beaman, Eltopia, WA (US)

(72) Inventor: David E. Beaman, Eltopia, WA (US)

(21) Appl. No.: 19/464,989

(22) Filed: Jan. 30, 2026

Related U.S. Application Data
(60) Provisional application No. 63/710,874, filed on Oct. 23, 2024.

(51) Int. Cl. B61K 9/04; B60T 17/22; F16D 66/00; G01K 1/024; G01K 3/00; G01K 11/06; G01M 13/04

(52) U.S. Cl. CPC B61K 9/04; B60T 17/22; F16D 66/00; G01K 1/024; G01K 3/005; G01K 11/06; G01M 13/04; F16D 2066/006

(57) ABSTRACT

The present invention provides a railway safety detection system that provides unmistakable visible and/or electronic signals of pending failures due to failed or distressed wheel bearings, the system employing one or more heat sensitive components (HSCs) connected with the train wheel's bearing bolts, the HSCs being designed to conduct heat from the bearing bolts and containing disks connected by heat-sensitive adhesives designed to dissociate upon reaching elevated operating temperatures such that the disks delaminate from one another exposing a highly reflective or otherwise highly noticeable surface providing an unmistakable visual signal and/or an electronic signal of the state of distress affecting the associated wheel bearing.

### FIELD OF THE INVENTION

The technology relates to railway safety systems and devices. More specifically, the technology relates to a railway train wheel bearing failure monitoring system, and more specifically to a monitoring system for assessing and identifying train wheel bearing failure prior to a catastrophic loss-of-integrity event.

### BACKGROUND OF THE INVENTION

The Norfolk Southern freight train derailment in East Palestine, Ohio on Feb. 3, 2023 brought significant public attention to the realities of train and railway safety in the 21^{st} century. In the U.S. alone, nearly 1,300 trains have derailed annually since 2015, an average of more than 3 per day. Most train derailments are somewhat innocuous, but derailments have resulted in the deaths of 144 people since 1975, according to the U.S. Department of Transportation's Bureau of Transportation Statistics, and more than 12,500 injuries have resulted from train-related accidents, the most common of which are derailments, which account for more than 70% of railway accidents.

There are many causes of train derailments, including mechanical failures, track structural failures, insufficient maintenance, signal failures, and operator errors. Among the most common causes of train derailments is wheel bearing failure, often due to a failure to maintain components resulting from an inability to easily observe and assess the need for maintenance. The National Transportation Safety Board's (“NTSB”) investigation into the East Palestine derailment found that a failed wheel bearing was the primary cause of the derailment, which resulted in significant environmental harm, health impacts, and property damage.

Overheated and/or failed wheel bearings are one of the most common causes of railway accidents, derailments included. Nevertheless, the ability to monitor and address an overheating, failing, or failed wheel bearing on a railway car remains limited. And such solutions typically rely on adding detection system infrastructure along the railroad tracks, which has proved prohibitively expensive and far from effective. As such, in many if not most instances, these solutions fail to provide sufficient warning to operators to stop the train before a complete failure and/or catastrophic event occurs, such as a derailment as was the case in East Palestine.

One such train bearing-failure detection system operates using acoustic detection, commonly known as “trackside acoustic detection system” or “TADS.” The TADS design requires adding wayside microphone arrays along train tracks, which arrays are designed to detect an acoustic signal characteristic of distressed bearings. The acoustic distress signal, when detected, is electronically routed to the train operators and crew, thereby theoretically providing notification of the distressed bearings in real-time. However, TADS routinely fails to identify defective bearings at the early stage in bearing-failure development, both because of the technology's inherent limitations operating based upon acoustics in a necessarily loud environment and because of the lack of widespread and reliable infrastructure deployment. Indeed, fewer than 20 TADS are currently in service throughout the U.S. and Canada, suggesting that TADS are either ineffectual, cost prohibitive, or both.

A second train bearing-failure detection system is commonly referred to as “hot bearing detectors” or “hot box detectors” or “HBD.” HBD systems assess train bearing failures based upon detection of excessive levels of heat, rather than upon sound. HBD systems, like TADS, employ a track-side sensor array along train tracks, only the HBD sensors detect heat while the TADS sensors detect acoustics. Typical implementations of HBD systems—around 6000 such systems are reportedly in operation throughout North America—require placement of sensor array infrastructure anywhere from every 5 miles of track to every 40 miles of track.

Due to many of the same drawbacks as TADS suffer from, HBD systems have proven to be likewise highly unreliable. A lot can go wrong with train wheel bearings over 5 miles of track, and a lot more can go wrong over 40 miles. Sensor arrays can fail, and infrastructure maintenance is tedious and undependable, not to mention the expense of maintaining and installing the infrastructure in the first place. And as with TADS, HBD systems rely on remote detection instrumentation and notification systems, which are often unreliable particularly in remote areas that trains often travel through. Thus, HBD systems, while more widely adopted, suffer from the same significant drawbacks and limitations as do TADS.

Other similar systems have been proposed, but all suffer from the same basic drawbacks and limitations—cost constraints limit the coverage of the detection infrastructure and long gaps in detection coverage permit a train bearing to go from normal to distressed to failure to train accident all long before any part of the detection system can be engaged. There hence remains a significant need in railway safety for a train bearing failure detection system capable of easier and more frequent system detection infrastructure implementation and of more robust concern/failure notification and communication.

### SUMMARY OF THE INVENTION

Accordingly, it is an object of the present invention to provide an improved system for detecting train wheel bearing wear, distress, and failure before the same has the opportunity to cause further harm, e.g. derailment or other railway accident. It is also an object of the present invention to provide for easy visual inspection to determine if bearings are nearing or suffering from failure in real-time as train cars are in service and proceeding along the tracks. It is further an object of the present invention to provide a detection system that travels with the train. It is still further an object of the present invention to employ simple technology and infrastructure that does not create overburdensome and prohibitive costs of implementation.

It is also an object of the present invention to provide a failure-detection system that does not require special knowledge to assess when bearings are suffering from excessive wear such that even the general public can assist in assessing and warning train operators of bearing distress and failure. Indeed, all of the approximately 212,000 highway-grade railroad crossings throughout the U.S., as well as innumerable other below-grade crossings, provide observation points at which bearing wear, distress, or failure can be observed and identified, according to preferable embodiments of the present invention.

Accordingly, preferable embodiments of the present invention are simple, robust, environmentally benign, lightweight, inexpensive, and require no on-board power. Installation of the components according to preferable embodiments of the present invention does not require special tools, skills, or training, and said components can be easily retrofitted onto train bearings already in service without taking the train car out of service or otherwise disturbing the wheel set. Such components are preferably capable of retrofitting to any train bearing technology extending back decades.

Preferable embodiments of the present invention provide a system capable of continuous, in-transit, visual and electronic assessment of the health and function of train wheel bearings, which reach highly elevated temperatures as they begin to experience distress in route to failure. Preferable embodiments of the system include sensors affixed to the train wheel bearings to detect, register, and archive bearing temperatures in real-time.

Preferable embodiments of the present invention further provide for both visual and electronic detection and passive electronic notification to train operators of any heat-related anomaly affecting a wheel bearing, including those reaching 130 degrees Fahrenheit, indicating a bearing in distress, up to 180 degrees Fahrenheit, indicating a bearing at the point of failure, or even higher. As those of skill in the art will recognize, these temperature levels are exemplary only, and the system of the present invention can be configured to operate at alternative temperatures where preferred by train operators, regulatory agencies, and the like.

The present invention includes a series of heat sensitive components (“HSCs”) that attach to the bolts used to retain the train wheel bearing outer cap. These bolts terminate deep withing the axle upon which the bearings are mounted, and the bolts accordingly provide an excellent heat ductile pathway between the train bearings and the HSCs. For older train bearing designs without access to these bolts, the HSCs can be affixed to the outer surface of a journal box lid or elsewhere to create a mechanical and, more importantly, thermal connection between the bearings and the HSCs; arrangements to provide for such thermal connection for various older train bearing designs will be ascertainable by those of skill in the art.

Preferable embodiments of the present invention will include at least 3 HSCs, although more or less HSCs may be utilized in some preferable embodiments, as will be understood to those of skill in the art. One HSC may be affixed to one or more of the three bearing bolts, or one or more HSCs may be affixed to each of the three bearing bolts, or all HSCs may be affixed to a single bearing bolt. Whatever the arrangement, the HSCs are designed to provide for visual detection of elevated temperature affecting the associated bearing bolt and, thereby, affecting the associated train wheel bearing.

In some preferable embodiments, the HSCs consist of a disk affixed to the bearing bolt's outer surface with a heat-sensitive adhesive. Upon reaching a certain temperature, the adhesive loses the ability to retain the disk to the bearing bolt, resulting in a readily recognizable state of distress in the associated bearing caused by elevated temperatures. In some preferable embodiments, the HSC may consist of two disks with adhesive therebetween, with the inner disk mechanically, adhesively, or otherwise reliably affixed to the bearing bolt or other usable component using a reliable, non-heat-sensitive adhesive in preferable embodiments, and the outer disk attached in turn to the inner disk by an appropriate type of heat-sensitive adhesive.

In such preferable embodiments, the inner disk may employ a shiny, brightly colored, or otherwise highly noticeable outer surface such that, when the heat-sensitive adhesive dissociates and the outer disk delaminates from the inner disk as a result, the visual signal created by the exposed inner disk will be unmistakable to viewers who can then contact the train operators to warn of the distressed bearing. Likewise, inspectors of the associated train car will immediately recognize the bearing problem upon visual inspection after the train has stopped and can take the train car out of service for repair, long before bearing failure and the associated harms, derailment included, can be realized.

In some preferable embodiments, the HSCs can be color coded and provided to indicate the temperature levels the bearing has reached. For example, one HSC inner disk may be provided with a shiny green surface, one with a shiny yellow surface, and one with a shiny red surface, each designed to indicate the associated bearing has reached a specific temperature level. In such an assembly of the present invention's HSCs, an observer can readily determine if one of the HSCs delaminated at 130 degrees Fahrenheit and is thus reflecting a shiny green surface, a second of the HSCs delaminated at 155 degrees Fahrenheit and is thus reflecting a shiny yellow surface, and a third of the HSCs delaminated at 180 degrees Fahrenheit and is thus reflecting a shiny red surface.

Notably, these color and temperature combinations are intended to be exemplary only, and the HSCs and associated heat-sensitive adhesives can be provided to dissociate and delaminate at any temperature operators, stakeholders, and/or regulators prefer to accomplish the bearing distress detection goals of the present invention. Likewise with respect to the coloring, design, and assembly of the HSCs. The combined rotational and lateral motion of the rolling reflective surfaces of the HSCs would be easily noticeable and distinguishable during train operation, creating a unique, somewhat quixotic “hopping bunny” pattern that is unmistakable during daytime or nighttime operation.

In addition to the unmistakable visual signal created by the exposure of the shiny, colored, light reflective, and/or otherwise highly noticeable surface of the exposed inner disk of the HSCs, preferable embodiments of the present invention's HSCs also employ one or more attached or imprinted passive integrated transponder (“PIT”) tag or the like, preferably attuned to reflect the standard AEI transponder signal or its radio frequency (RF) derivative. Thereby, in addition to the visual signal created by the exposed surface of the inner disk, an electronic signal can be provided directly to the train operators if and when one of the HSCs dissociates and delaminates, offering the train operator real-time information and providing the ability to stop the train and inspect the bearing to determine whether the train car requires immediate service, etc.

Preferable embodiments of the present invention are also designed to interface and/or interact with existing equipment and technology employed on many rail transport systems, including, for example, the automatic equipment identification (“AEI”) system utilized by the Association of American Railroads (“AAR”). The PIT tag employed in preferable embodiments of the HSCs of the present invention may be programmed, in addition to other programming such as geolocation sharing, movement reporting, etc., to interface with existing AEI infrastructure to provide electronic notification of any previously detected or ongoing bearing temperature anomaly anytime the PIT tag enters into electronic communication with an AEI transponder or other component. In some cases, other electronic devices are utilized by railroad employees and train operators to interact with the AEI system, in which case those electronic devices could also reflect the information shared by the PIT tag of the HSCs of the present invention, as those of skill in the art will recognize.

The one or more HSCs of the present invention preferably include at least two substantially flat, and preferably disk-like components (referred to throughout as inner and outer disks, although they need not have a circular cross-sectional shape) connected to one another using heat-sensitive adhesive. The outer disk is preferably comprised of an opaque, waterproof, semi-flexible, abrasion-, chemical-, and UV-tolerant material. The exposed, outer surface of the outer disk is may also be color-coded, preferably using a muted, non-reflective paint or other material, to indicate the temperature at which the HSC is configured to activate.

Preferable embodiments of the HSCs of the present invention include a Mylar (or similar material) shielding or coating on the inner surface of the outer disk, which coating is preferably capable of blocking unwanted electronic signals from reaching the PIT tag and of cloaking electronic signals emitted by the PIT tag. The Mylar shield material may be part-in-parcel to the outer disk or may be permanently affixed to the outer disk's inner surface, as will be understood to those of skill in the art. Accordingly, electronic signals from the PIT tag can be substantially cloaked unless or until the outer disk of the associated HSC delaminates as a result of excess heat.

Preferable embodiments of the inner disk of the HSCs of the present invention include the noted highly noticeable outer facing surface that, when exposed, will provide a highly recognizable visual signal of a temperature-related anomaly affecting the associated bearing. A PIT tag may be affixed to or otherwise embedded in either or both of the inner disk, in preferable embodiments where included. In some preferable embodiments, the inner disk is affixed to the train wheel bearing bolt or other associated bearing part, and the inner and outer disks are connected to one another using the aforementioned heat-sensitive adhesive, designed to permanently connect the inner and outer disks unless and until the HSC experiences a temperature-related event. The heat-sensitive adhesives are available to activate at a broad spectrum of temperature levels, as will be known to those of skill in the art but are preferably provided to activate in the 130-180 degree Fahrenheit range for purposes of the present invention.

Intact HSCs will remain dormant for years or until the specified temperature threshold is exceeded, whereupon the entire outer disk, including the attached or incorporated Mylar cloak, will delaminate, allowing the outer disk to fall away thereby exposing the outer surface of the inner disk. The inner disk remains secured to the bearing bolt face, whether mechanically, through a non-heat-sensitive permanent adhesive, a combination thereof, or through other means that will be known to those of skill in the art. With the outer disk removed and the outer surface of the inner disk exposed, the HSC provides the visual signal created by the inner disk's highly noticeable outer surface, and the PIT tag is free to emit its electronic signals to indicate activation of the HSC and the associated distress in the bearing.

Note that in some preferable embodiments, the PIT tag may fall away from the inner disk such that the electronic signal will then indicate the PIT tag's dissociation with the train, whether through geolocation sharing or other data disclosure function, as will be known to those of skill in the art. Once activated, the HSC will remain in the activated state until repaired or replaced. In some preferable embodiments of the present invention, a receptacle may be provided to capture falling outer disks and retain them in the vicinity of the associated HSC. Such preferable embodiments provide environmental benefits by preventing littering and facilitating recycling and also improve maintenance activities by allowing the outer disk to be replaced using the proper heat-sensitive adhesive once the bearing has been inspected and repaired as necessary.

The bearing distress detection system of the present invention provides certain other advantages as well. One such advantage is to improve and enhance diagnostic capabilities associated with train braking systems. Typical train braking systems apply brakes to the outer face of train wheel rims, well away from the wheel bearing assemblies in common brake system designs. In certain extreme braking conditions, such as an urgent braking event, the brakes themselves may create sufficient heat to trigger commonly used bearing failure detection systems, such as HBD systems. HBD systems, with detection components disconnected and remote from the train wheels themselves, are commonly triggered by such urgent braking events, creating false positives in the HBD systems and other similar bearing failure detection systems.

Because the HSCs of the present invention are placed on the bearing bolts, well away from the location of friction created during braking, false positive detection events are far less likely. Furthermore, in the case where an urgent braking event creates sufficient heat to cause inadvertent activation of an HSC of the present invention, the deployment of several HSCs on the each bearing provides a level of redundancy that can be used to diagnose other potential causes, such as sticking brakes, an urgent braking event, or the like. For example, if HSCs on several wheel bearings activate all at the same time, it would be unlikely that such activations were caused by simultaneous bearing failures on multiple wheels rather than by an urgent braking event or other brake-related issue. At the same time, the activation of only one of three or more HSCs on a single bearing might likewise suggest a brake-related activating event, rather than bearing failure as the cause.

Since high bearing temperatures will typically activate more than one HSC on a single bearing, the present invention can provide a reliable redundant, sequential notification feature enabling personnel to distinguish between overheated brakes and pending bearing failure. In the event multiple carriages in the same train were to display similar low-level, heat-related anomalies, it may be an indication the locomotive lacks sufficient dynamic braking capacity for its load, thereby requiring excess air brake usage someplace along the line. In other instances, such activation might indicate the need for more advantageous placement of distributive power. And in the event of a derailment, the on-board heat indicators of the present invention can be used to help determine if either over-heated bearings or excessive braking may have been the primary or a contributing factor.

Notably the HSCs of the present invention can also easily be combined with other, currently-in-use, bearing wear detection systems with virtually no interference with the performance thereof. The present invention's detection system also benefits from its application directly to the train cars themselves, rather than requiring additional infrastructure be provided along the tracks, thereby facilitating maintenance and replacement of the HSCs and reducing the costs associated with implementing the bearing wear detection system of the present invention.

The use of several HSCs on each wheel bearing provides a level of redundancy that can mitigate any harm caused by nonperformance or failure to reliably activate by any one HSC, although such is highly improbable given the heat-sensitive adhesive activation method. Likewise with respect to tampering or other physical damage, whether incidental or intentional, which is unlikely to affect all of the HSCs implemented on any single bearing. The present invention also provides for easy and quick field replacement and maintenance.

As those skilled in the art will appreciate, the present invention is not limited to the embodiments and arrangements described above. Other objects of the present invention and its particular features and advantages will become more apparent from consideration of the following drawings and detailed description of the invention.

### BRIEF DESCRIPTION OF THE DRAWINGS

FIG. 1 depicts a train wheel bearing equipped with preferable embodiments of the present invention.

FIG. 2 depicts a train wheel bearing equipped with the preferable embodiments of the present invention depicted in FIG. 1.

FIG. 3 depicts a train wheel bearing equipped with the preferable embodiments of the present invention depicted in FIGS. 1-2.

FIG. 4 depicts a train wheel bearing equipped with the preferable embodiments of the present invention depicted in FIGS. 1-3.

FIG. 5 depicts a train wheel bearing equipped with the preferable embodiments of the present invention depicted in FIGS. 1-4.

FIG. 6 depicts a train wheel bearing equipped with the preferable embodiments of the present invention depicted in FIGS. 1-5.

FIG. 7 depicts a train wheel bearing equipped with the preferable embodiments of the present invention depicted in FIGS. 1-6.

FIG. 8 depicts a train wheel bearing equipped with the preferable embodiments of the present invention depicted in FIGS. 1-7.

FIG. 9 depicts a train wheel bearing equipped with the preferable embodiments of the present invention depicted in FIGS. 1-8.

### DETAILED DESCRIPTION OF THE INVENTION

The following detailed description illustrates the technology by way of example, not by way of limitation of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

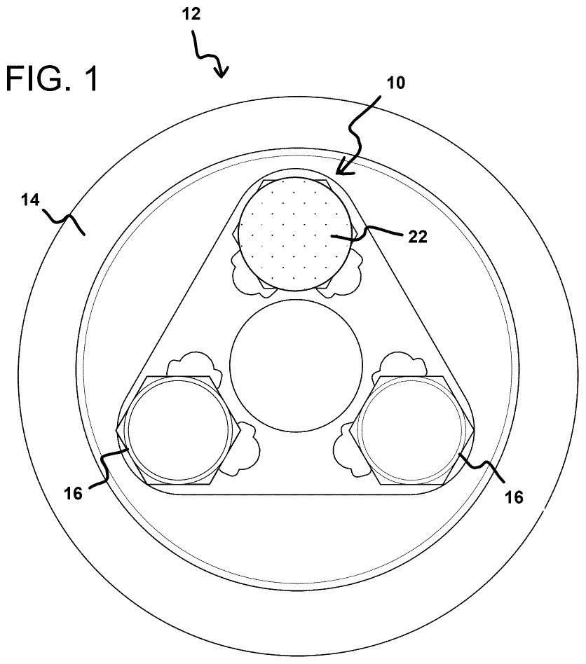

Referring first to FIG. 1, depicted is a train wheel bearing outer cap 14 equipped with an HSC 10 according to preferable embodiments of the present invention. Depicted is the outer surface of the outer disk 22 of the HSC 10, which is preferably opaque, waterproof, semi-flexible, abrasion-, chemical-, and UV-tolerant material and may be color-coded, preferably using a muted, non-reflective coloring or shade, indicative of the temperature at which the HSC 10 is configured to activate. In preferable embodiments of the present invention, an HSC 10 can be applied to one or more of the three depicted bearing bolts 16 attaching the wheel bearing cap 14, and more than one HSC 10 can be applied to any or all of the three depicted bearing bolts 16 in some preferable embodiments.

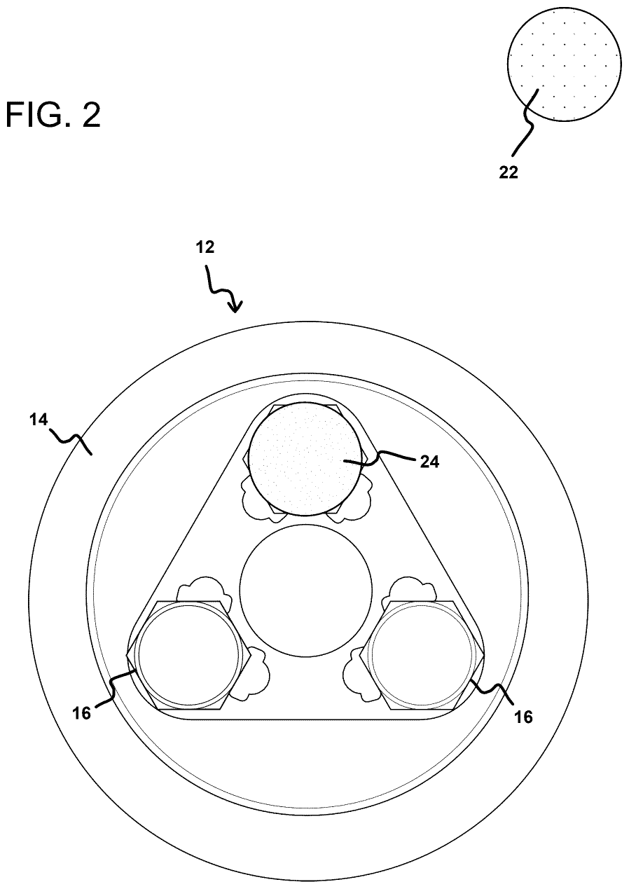

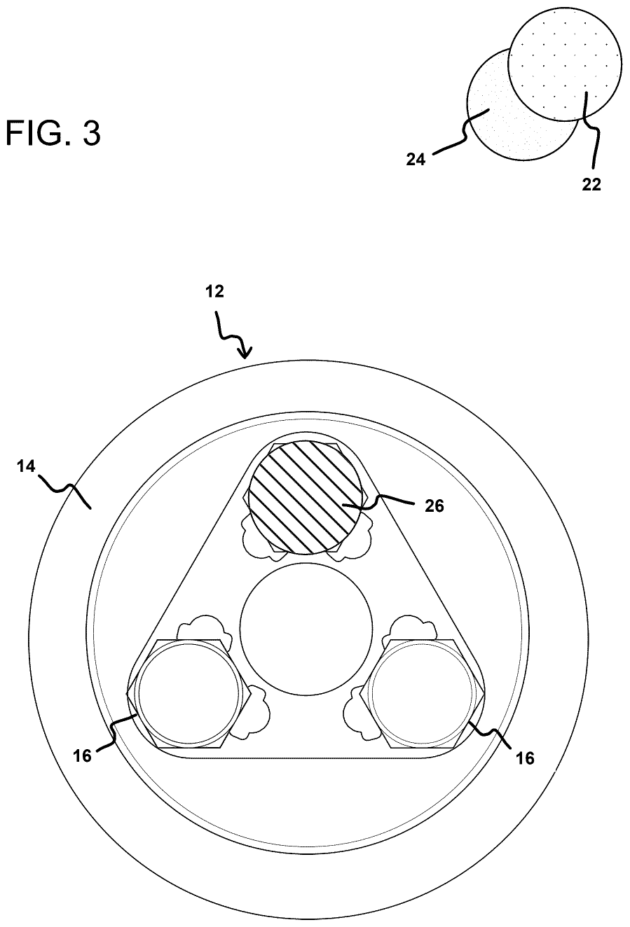

Referring to FIG. 2, below the outer surface of the outer disk 22, in some preferable embodiments, is a layer of permanent adhesive material 24 connecting the Mylar (or similar material) layer 26, as depicted in FIG. 3. The Mylar shield 26, which may be part-in-parcel to the outer disk 22 in some preferable embodiments, is preferably applicable to block unwanted electronic signals from reaching the PIT tag 34 and to cloak electronic signals emitted by the PIT tag 34.

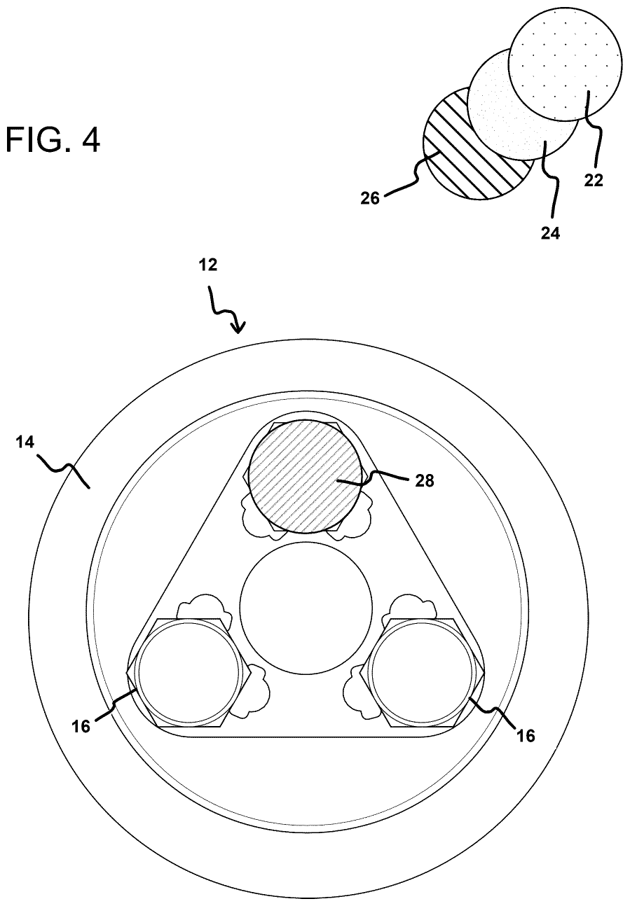

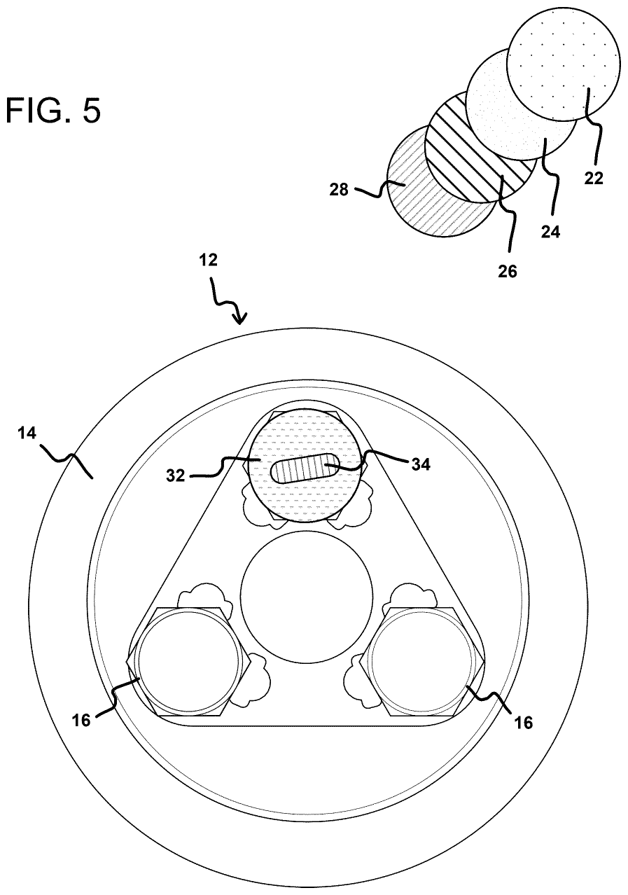

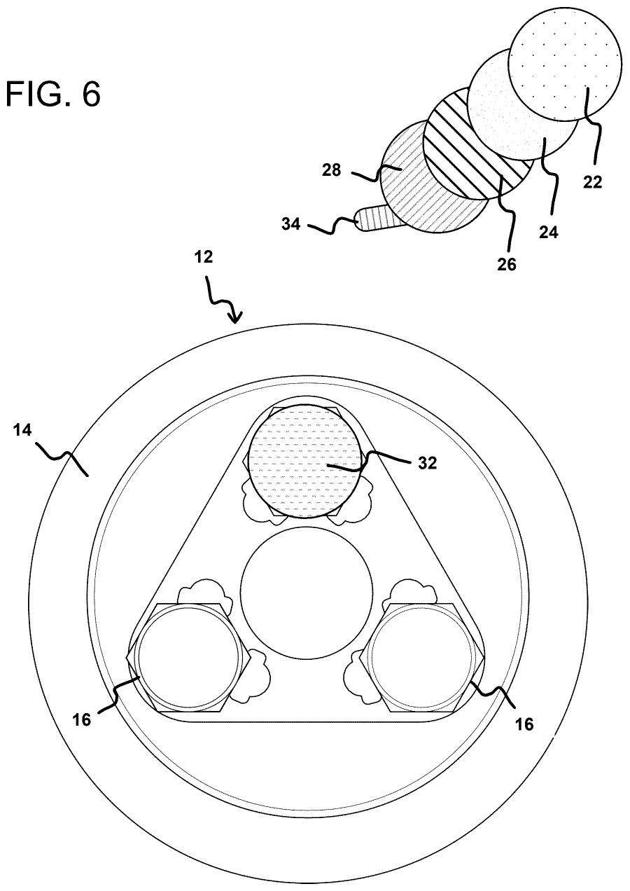

Referring now to FIG. 4, the heat-sensitive adhesive layer 28 connecting the outer disk 22 to the inner disk 32 is depicted. The heat-sensitive adhesive 28 dissociates and loses the ability to retain the outer disk 22 to the inner disk 32, upon reaching an ascertainable temperature, and the outer disk 22 thus delaminates, exposing the outer surface of the inner disk 32 found thereunder. As depicted in FIGS. 5 and 6, the outer surface of the inner disk 32 employs a highly distinct and easily noticeable outward facing surface, preferably including one or more of a shiny, highly-reflective, color-coded, and/or otherwise easily distinguishable presentation such that observers of the train from the outside will see the unmistakable visual signal that the wheel bearing 12 is in a state of distress.

Also depicted in FIG. 5 specifically is a preferable embodiment of the HSC 10 of the present invention including a PIT tag 34. As depicted, the PIT tag 34 is preferably present between the outer and inner disks 22, 32 such that it can be dropped upon dissociation of the heat-sensitive adhesive 28 or can be retained upon the outer surface of the inner disk 32 to emit ongoing electronic signals, as determined by operators, regulators, and/or best-use standards. In such preferable embodiments, the PIT tag 34 will relay to the train operators or other train safety personnel, preferably via electronic means such as geolocation tagging or otherwise, as will be known to those of skill in the art, that the PIT tag 34 is either no longer present on the wheel bearing 12 having been left behind or has been uncovered by the blocking Mylar layer 26 and is now successfully able to emit its electronic signal, providing redundancy with the visual signal to notify train operators when an HSC 10 according to the present invention is indicating a state of distress among the train wheel bearings 12.

In some preferable embodiments where the PIT tag 34 remains with the HSC 10 after delamination, the PIT tag 34 may be attached to or embedded within the inner disk 32. Once the outer disk 22 and its associated Mylar shield 26 (or other electronic signal blocking mechanism or material) is removed and the outer surface of the inner disk 32 is exposed, the PIT tag 34 in such configurations is permitted to transmit its electronic signal, likewise providing redundancy with the visual signal to notify train operators when a bearing 12 is in distress. Other arrangements whereby the PIT tag 34 can enhance the bearing distress detection objectives are likewise available for use with the present invention, as will be recognized by those of skill in the art.

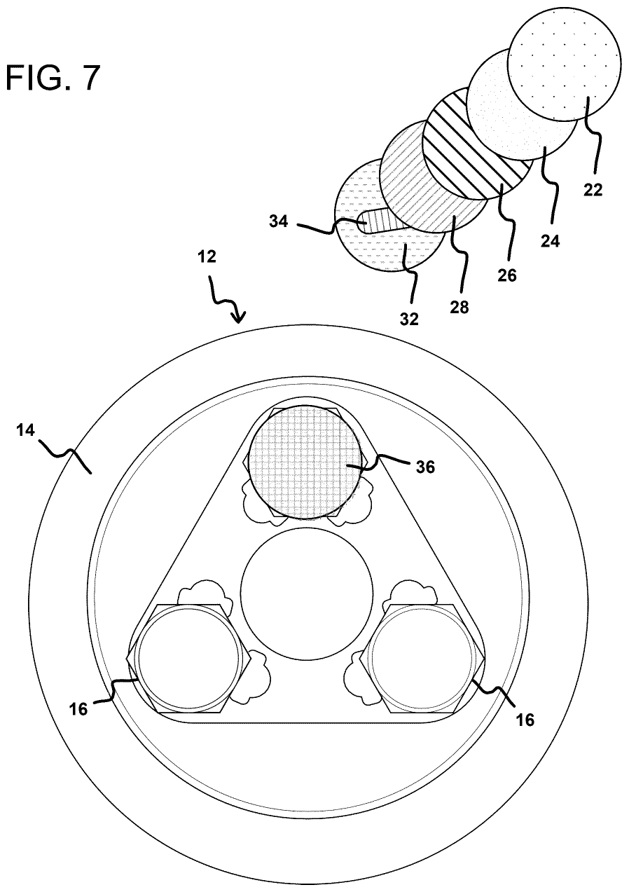

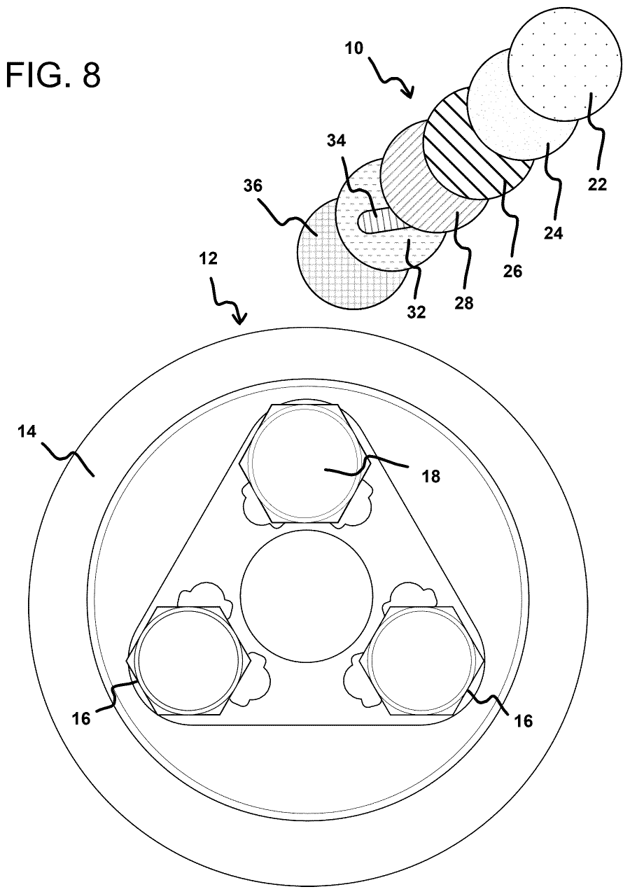

Below the inner disk 32, as depicted in FIG. 7, is a base adhesive 36 connecting the inner disk 32 to the bolt face 18, as depicted in FIG. 8. The base adhesive 36 is preferably NOT heat-sensitive and thus maintains its adhesive properties even in the case of extreme high temperatures. As a result, the inner disk 32 remains connected to the bearing bolt 16 even in the presence of extreme heat indicating a bearing 12 failure or other catastrophic bearing event. Some preferable embodiments may employ alternative means of connecting the inner disk 32 to the bearing bolt face 18 instead of using a non-heat-sensitive adhesive 36, as will be understood by those of skill in the art.

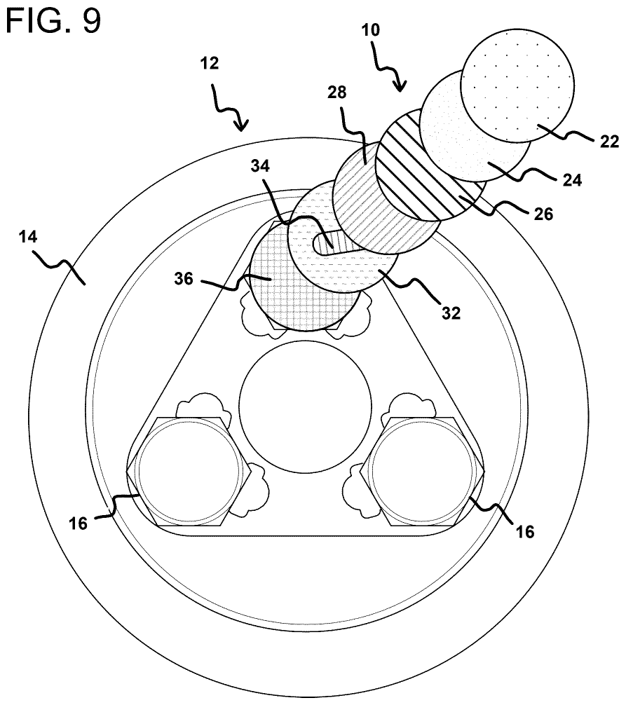

FIG. 9 depicts the various layers of an HSC 10 according to preferable embodiments of the present invention. As noted, preferable implementations of the present invention employ three or more HSC 10 to each bearing, each of which can be provided with heat-sensitive adhesive layers 28 designed to dissociate at different temperatures. In some preferable embodiments, for example, a first HSC 10 can be designed to dissociate, allowing delamination, at 130 degrees Fahrenheit, a second at 155 degrees Fahrenheit, and a third at 180 degrees Fahrenheit, although these temperatures are exemplary only, and the same functionality can be employed at any desired temperature levels.

In some preferable embodiments, a single HSC 10 can be equipped with all three such layers of adhesives, such that the HSC 10 operates as a “stack” of HSCs 10. In such preferable embodiments, a single bearing bolt 16 may have a first inner disk 32a connected thereto, the first inner disk 32a connected to a first outer disk 22a using a first heat-sensitive adhesive 28a designed to dissociate at the highest temperature (e.g. 180 degrees Fahrenheit), a second inner disk 32b connected to the first outer disk 22a using a non-heat-sensitive adhesive 36, a second outer disk 22b connected to the second inner disk 32b using a second heat-sensitive adhesive 28b designed to dissociated at a lower temperature (e.g. 155 degrees Fahrenheit), a third inner disk 32c connected to the second outer disk 22b using a non-heat-sensitive adhesive 36, and a third outer disk 22c connected to the third inner disk 32c using a third heat-sensitive adhesive 28c designed to dissociated at the lowest temperature (e.g. 130 degrees Fahrenheit).

Accordingly, the “stacked” HSC 10 is capable of providing elevating levels of visual/electronic signals using the associated PIT tag 34 connected to one or more of the inner disks 32 as the temperature associated with the associated bearing bolt 16 rises. Some preferable embodiments may employ multiple inner disks 32 with color-coded outer surfaces intended to indicate a progressively higher level of concern as each outer disk 22 delineates, such as green for the third or outer-most inner disk 32c, yellow for the second inner disk 32b, and red for the first or inner-most inner disk 32c, indicating the highest temperature level has been reached and the associated bearing 12 is in the highest level of distress. As those of skill in the art will understand, such “stacked” HSCs 10 must employ highly heat-conductive materials, both in the disks themselves and the adhesives, so that heat dissipation does not inhibit the present invention's functionality, as is the case with all HSC 10 designs according to the present invention but even more so in the case of the “stacked” HSC 10 design.

The “stacked” HSC 10 design need not be limited in number of inner and outer disks 22, 32 provided, as will be understood by those of skill in the art, and any number of disks 22, 32 could be provided with the effect of delaminating at various temperatures so long as the number does not become so great so as to inhibit the heat conductivity from the bearing bolt 16 to the outer most disk 22. Likewise, such “stacked” HSCs 10 may be applied to a single bearing bolt 16, to each of the bearing bolts 16 present, or any combination in between, or combined with standard, single outer and inner disk HSC 10 designs, such as those depicted in FIGS. 1-9. Those of skill in the art will recognize the various arrangements and the anticipated benefits and/or drawbacks thereof, and train operators, safety administrators, and regulators are free to implement the safety system of the present invention in any such combination to maximize performance and avoid train accident, derailment, or other safety event.

While the present invention has been described with reference to particular embodiments and arrangements of parts, features, and the like, it is not limited to these embodiments or arrangements. Indeed, modifications and variations will be ascertainable to those of skill in the art, all of which are inferentially and inherently included in these teachings.

What is claimed is:

1. A train wheel bearing heat detection device comprised of heat sensitive and heat conductive components comprising:
an outer disk comprising an outer disk outer surface and an outer disk inner surface, an inner disk comprising an inner disk outer surface and an inner disk inner surface, the outer disk inner surface being affixed to the inner disk outer surface using a heat-activated adhesive;
whereby the outer disk delaminates from the inner disk when the heat-activated adhesive reaches a predetermined temperature, exposing the inner disk outer surface.

2. The train wheel bearing heat detection device comprised of heat sensitive and heat conductive components of claim 1, wherein the inner disk comprises a heat-conductive material and the inner disk outer surface is brightly colored and highly reflective, rendering it immediately noticeable upon visual inspection.

3. The train wheel bearing heat detection device comprised of heat sensitive and heat conductive components of claim 1, wherein the outer disk comprises a heat-conductive, waterproof, semi-flexible, abrasion tolerant, chemical tolerant, and UV tolerant material, the outer disk outer surface comprising an opaque, non-reflective coloring.

4. The train wheel bearing heat detection device comprised of heat sensitive and heat conductive components of claim 1, further comprising an electronic signal emitting device operating to emit an electronic notification signal.

5. The train wheel bearing heat detection device comprised of heat sensitive and heat conductive components of claim 4, wherein the electronic signal emitting device comprises a passive integrated transponder tag attuned to emit a standard AEI transponder signal or its radio frequency alternative.

6. The train wheel bearing heat detection device comprised of heat sensitive and heat conductive components of claim 4, wherein the electronic signal emitting device is affixed to the inner disk outer surface using the heat-activated adhesive such that the electronic signal emitting device delaminates from the inner disk concurrently with the outer disk upon reaching the predetermined temperature, the electronic notification signal comprising the electronic signal emitting device's geolocation.

7. The train wheel bearing heat detection device comprised of heat sensitive and heat conductive components of claim 4, further comprising an electronic signal blocking layer affixed to the outer disk inner surface using a heat-conductive, non-heat-sensitive adhesive, the electronic signal blocking layer operating to prevent transmission of the electronic notification signal from the electronic signal emitting device.

8. The train wheel bearing heat detection device comprised of heat sensitive and heat conductive components of claim 7, wherein the electronic signal blocking layer comprises a heat-conductive, electrical insulating material, such as Mylar.

9. The train wheel bearing heat detection device comprised of heat sensitive and heat conductive components of claim 1, wherein the inner disk inner surface is affixed, using a heat-conductive and non-heat-sensitive base adhesive, to an exposed face of a bearing bolt used to retain a train wheel bearing outer cap, the inner disk remaining affixed to the exposed face of the bearing bolt whatever temperature is reached.

10. A system for detecting an impending train braking failure, the system comprising:
affixing one or more of the train wheel bearing heat detection devices comprised of heat sensitive and heat conductive components of claim 1 to one or more exposed faces of one or more bearing bolts used to retain a train wheel bearing outer cap,
an outer disk of each of the one or more train wheel bearing heat detection devices operating to delaminate from an inner disk of each of the one or more train wheel bearing heat detection devices upon reaching a predetermined temperature,
the inner disk of each of the one or more train wheel bearing heat detection devices comprising a highly-reflected and brightly colored inner disk outer surface, providing a visual signal of distress upon delamination of the associated outer disk exposing the inner disk outer surface.

11. The system of claim 10, the one or more train wheel bearing heat detection devices each further comprising an electronic signal emitting device operating to emit an electronic notification signal upon delamination of the associated outer disk.

12. The system of claim 10, the system further comprising a receptacle associated with each of the one or more train wheel bearing heat detection devices operating to catch each associated outer disk upon its delamination.

13. A train wheel bearing heat detection device comprised of heat sensitive and heat conductive components comprising:
a first outer disk comprising a first outer disk outer surface and a first outer disk inner surface, a first inner disk comprising a first inner disk outer surface and an inner disk inner surface, the first outer disk inner surface being affixed to the first inner disk outer surface using a first heat-activated adhesive;
at least one additional disk comprising an at least one additional disk outer surface and an at least one additional disk inner surface, the first inner disk inner surface being affixed to the at least one additional disk outer surface using an at least one additional heat-activated adhesive;
whereby the first outer disk delaminates from the first inner disk when the first heat-activated adhesive reaches a first predetermined temperature, exposing the first inner disk outer surface, and the first inner disk delaminates from the at least one additional disk when the at least one additional heat-activated adhesive reaches an at least one additional predetermined temperature, exposing the at least one additional disk outer surface.

14. The train wheel bearing heat detection device comprised of heat sensitive and heat conductive components of claim 13, wherein:
the at least one additional disk comprises a second outer disk and a third outer disk, the second outer disk comprising a second outer disk outer surface and a second outer disk inner surface, the third outer disk comprising a third outer disk outer surface and a third outer disk inner surface;
the at least one additional disk further comprises a second inner disk and a third inner disk, the second inner disk comprising a second inner disk outer surface and a second inner disk inner surface, the third inner disk comprising a third inner disk outer surface and a third inner disk inner surface;
the at least one additional heat-activated adhesive comprises a second heat-activated adhesive and a third heat-activated adhesive, and the at least one additional predetermined temperature comprises a second predetermined temperature and a third predetermined temperature;
the first inner disk inner surface being affixed to the second outer disk outer surface using a heat-conductive, non-heat-sensitive adhesive and the second outer disk inner surface being affixed to the second inner disk outer surface using the second heat-activated adhesive;
the second inner disk inner surface being affixed to the third outer disk outer surface using a heat-conductive, non-heat-sensitive adhesive and the third outer disk inner surface being affixed to the third inner disk outer surface using the third heat-activated adhesive;
whereby the first outer disk delaminates from the first inner disk when the first heat-activated adhesive reaches the first predetermined temperature, exposing the first inner disk outer surface, the second outer disk delaminates from the second inner disk when the second heat-activated adhesive reaches the second predetermined temperature, exposing the second inner disk outer surface, and the third outer disk delaminates from the third inner disk when the third heat-activated adhesive reaches the third predetermined temperature, exposing the third inner disk outer surface.

15. The train wheel bearing heat detection device comprised of heat sensitive and heat conductive components of claim 13, wherein:
the first outer disk comprises a heat-conductive, waterproof, semi-flexible, abrasion tolerant, chemical tolerant, and UV tolerant material and the outer disk outer surface comprising an opaque, non-reflective coloring;
each of the at least one additional disk and the first inner disk comprises a heat-conductive material, the first inner disk outer surface is brightly colored and highly reflective, rendering it immediately noticeable upon visual inspection, and the at least one additional disk outer surface is brightly colored and highly reflective, rendering it immediately noticeable upon visual inspection.

16. The train wheel bearing heat detection device comprised of heat sensitive and heat conductive components of claim 13, further comprising at least one electronic signal emitting device operating to emit at least one electronic notification signal.

17. The train wheel bearing heat detection device comprised of heat sensitive and heat conductive components of claim 16, wherein:
the at least one electronic signal emitting device comprises a first electronic signal emitting device operating to emit a first electronic notification signal and a second electronic signal emitting device operating to emit a second electronic notification signal;
the first electronic signal emitting device being affixed to the first inner disk outer surface using the first heat-activated adhesive such that the first electronic signal emitting device delaminates from the first inner disk concurrently with the first outer disk upon reaching the first predetermined temperature, the first electronic notification signal comprising the first electronic signal emitting device's geolocation; and
the second electronic signal emitting device being affixed to the at least one additional disk outer surface using the at least one additional heat-activated adhesive such that the second electronic signal emitting device delaminates from the at least one additional disk concurrently with the first inner disk upon reaching the at least one additional predetermined temperature, the second electronic notification signal comprising the second electronic signal emitting device's geolocation.

18. The train wheel bearing heat detection device comprised of heat sensitive and heat conductive components of claim 17, further comprising:
a first electronic signal blocking layer affixed to the first outer disk inner surface using a heat-conductive, non-heat-sensitive adhesive, the first electronic signal blocking layer operating to prevent transmission of the first electronic notification signal from the first electronic signal emitting device; and
a second electronic signal blocking layer affixed to the first inner disk inner surface using a heat-conductive, non-heat-sensitive adhesive, the second electronic signal blocking layer operating to prevent transmission of the second electronic notification signal from the second electronic signal emitting device.

19. The train wheel bearing heat detection device comprised of heat sensitive and heat conductive components of claim 16, further comprising at least one electronic signal blocking layer affixed to at least one of the outer disk inner surface and the inner disk inner surface using a heat-conductive, non-heat-sensitive adhesive, the at least one electronic signal blocking layer comprising a heat-conductive, electrical insulating material and operating to prevent transmission of the at least one electronic notification signal from the at least one electronic signal emitting device.

20. The train wheel bearing heat detection device comprised of heat sensitive and heat conductive components of claim 13, wherein the at least one additional disk inner surface is affixed, using a heat-conductive and non-heat-sensitive base adhesive, to an exposed face of a bearing bolt used to retain a train wheel bearing outer cap, the at least one additional disk remaining affixed to the exposed face of the bearing bolt whatever temperature is reached.
